(19) United States
(12) Patent Application Publication
(10) Pub. No.: US 2026/0302479 A1
(43) Pub. Date: Oct. 1, 2026

(54) METHOD FOR MANUFACTURING BATTERY

(71) Applicant: HONDA MOTOR CO., LTD., Tokyo (JP)

(72) Inventor: Kazushige IWASAKI, Saitama (JP)

(73) Assignee: HONDA MOTOR CO., LTD., Tokyo (JP)

(21) Appl. No.: 19/578,918

(22) Filed: Mar. 26, 2026

(30) Foreign Application Priority Data
Mar. 28, 2025 (JP) 2025-056001

(51) Int. Cl. H01M 50/242; H01M 4/134; H01M 10/058; H01M 4/02

(52) U.S. Cl. CPC H01M 50/242; H01M 4/134; H01M 10/058; H01M 2004/027

(57) ABSTRACT

A method for manufacturing a battery includes: compressing the first laminate of the first assembly, supporting one of the first plates, and pressing other of the first plates by a first pressing member; and overlapping one of the second plates with the other of the first plates to stack the second assembly on the first assembly, and the first pressing member is accommodated in an accommodating recess provided in a surface of the other of the first plates facing outward in the laminating direction, and the surface of the other of the first plates protrudes further outward in the laminating direction than the first pressing member, and the first assembly and the second assembly are pressurized in the laminating direction, and in the pressurized state, the first pressing member is removed in a first direction intersecting the laminating direction.

### CROSS-REFERENCE TO RELATED APPLICATION

This application is based on and claims priority under 35 USC 119 from Japanese Patent Application No. 2025-056001 filed on Mar. 28, 2025.

### TECHNICAL FIELD

The present invention relates to a method for manufacturing a battery.

### BACKGROUND ART

In recent years, researches and developments have been conducted on a secondary battery which contributes to improvement in energy efficiency in order to allow more people to have access to affordable, reliable, sustainable and advanced energy.

A battery module described in Patent Literature 1 includes a pair of end plates that sandwich a battery laminate, in which a plurality of unit cells are laminated, in a laminating direction of the cells, and a restraint band that restrains the pair of end plates to pressurize the battery laminate. The pair of end plates each includes a concave-shaped restraint band fixing portion for fixing the restraint band, and a concave-shaped claw hooking portion for engaging with a jig for pulling the end plates in directions in which an interval between the pair of end plates is temporarily widened.

Patent Literature 1: JP7047733B

### SUMMARY OF INVENTION

For example, in a battery to be mounted on an electric vehicle such as an electric automobile, the number of laminated cells tends to increase in response to a request for a large capacity and/or a high voltage of the battery. As the number of cells increases, when the laminated cells and cushioning members sandwiching the cells are compressed, the cells and the cushioning members in an intermediate portion in a laminating direction are likely to be displaced in a direction perpendicular to the laminating direction.

An object of the present invention is to improve assemblability of a battery.

An aspect of the present invention is a method for manufacturing a battery in which a plurality of cushioning members and a plurality of cells each disposed between adjacent two of the cushioning members are laminated, the battery including:

a first assembly that includes

a first laminate including one or more of the cells and two or more of the cushioning members, and

a pair of first plates configured to compressively sandwich the first laminate in a laminating direction, and

a second assembly that includes

a second laminate including one or more of the cells and two or more of the cushioning members, and

a pair of second plates configured to compressively sandwich the second laminate in the laminating direction, the method comprising:

compressing the first laminate of the first assembly, supporting one of the first plates, and pressing the other of the first plates by a first pressing member; and

overlapping one of the second plates with the other of the first plates to stack the second assembly on the first assembly, wherein

the first pressing member is accommodated in an accommodating recess provided in a surface of the other of the first plates facing outward in the laminating direction, and the surface of the other of the first plates protrudes further outward in the laminating direction than the first pressing member, and

the first assembly and the second assembly are pressurized in the laminating direction, and in the pressurized state, the first pressing member is removed in a first direction intersecting the laminating direction.

According to the present invention, assemblability of the battery can be improved.

### BRIEF DESCRIPTION OF DRAWINGS

FIG. 1 is a front view schematically showing an example of a battery for illustrating an embodiment of the present invention.

FIG. 2 is a perspective view of an example of pressing members used for manufacturing the battery of FIG. 1.

FIG. 3 is a front view of the pressing members of FIG. 2.

FIG. 4 is a cross-sectional view of the pressing members of FIG. 2.

FIG. 5 sequentially shows an example of a method for manufacturing the battery of FIG. 1.

FIG. 6 sequentially shows the example of the method for manufacturing the battery of FIG. 1.

FIG. 7 sequentially shows the example of the method for manufacturing the battery of FIG. 1.

FIG. 8 is a perspective view of a modification of the pressing members of FIG. 2.

FIG. 9 shows another example of the method for manufacturing the battery of FIG. 1.

FIG. 10 sequentially shows an example of a method for manufacturing a modification of the battery of FIG. 1.

FIG. 11 sequentially shows the example of the method for manufacturing the modification of the battery of FIG. 1.

### DESCRIPTION OF EMBODIMENTS

An example of a battery and a method for manufacturing the battery, which illustrate an embodiment of the present invention will be described with reference to the accompanying drawings.

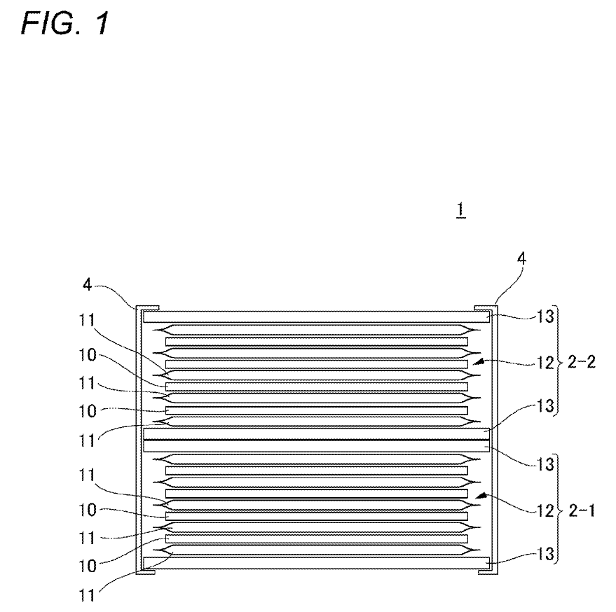

A battery 1 shown in FIG. 1 includes a plurality of cells 10 and a plurality of cushioning members 11. The cells 10 and the cushioning members 11 are flat or planar, and are laminated in a thickness direction. Each of the cells 10 is sandwiched between two adjacent cushioning members 11.

The plurality of cells 10 and the plurality of cushioning members 11 are divided into a plurality of sets, and each of the sets includes one or more cells 10 and two or more cushioning members 11, and a pair of plates 13 that compressively sandwich a laminate 12 of the cells 10 and the cushioning members 11 in a laminating direction is provided. The pair of plates 13 and the laminate 12 sandwiched between the pair of plates 13 constitute one assembly. The battery 1 shown in FIG. 1 includes two assemblies, including a first assembly 2-1 and a second assembly 2-2. The number of assemblies constituting the battery 1 is not limited to two, and may be three or more.

The first assembly 2-1 and the second assembly 2-2 are stacked in this order with laminating directions of the laminates 12 of the assemblies aligned. The battery 1 further includes frames 4 that restrain the stacked first assembly 2-1 and second assembly 2-2. The frames 4 restrain one plate 13 of the first assembly 2-1 and one plate 13 of the second assembly 2-2 disposed at both ends in the laminating direction, and fix an interval between the both.

The cell 10 is a so-called laminate cell in which a positive electrode, a negative electrode, a separator, and an electrolyte are sealed in a laminate film pack. In general, as compared with a can cell in which a material of the positive electrode or the like is sealed in a cylindrical or rectangular metal container, the laminate cell is high in energy density per volume and excellent in heat dissipation.

The cell 10 is, for example, a lithium-ion battery or nickel-hydrogen battery using a liquid electrolyte, or an all-solid-state battery using a solid electrolyte. In the all-solid-state battery, the solid electrolyte also serves as the separator. In general, as compared with a lithium-ion battery or the like using a liquid electrolyte, the all-solid-state battery is excellent in temperature resistance and has a long life.

In either a cell using the liquid electrolyte or a cell using the solid electrolyte, a material having an excellent energy density but a large expansion amount, such as metallic lithium, an alloy containing metallic lithium, or silicon (Si), may be used for the negative electrode. For example, on a surface of the negative electrode made of the metallic lithium or the like, lithium is deposited due to repeated charging and discharging. When there is a variation in an in-plane pressure distribution of the cell 10, precipitation of lithium may be biased. The biased precipitation of lithium promotes the precipitated lithium to grow into a protrusion shape, which may reach the positive electrode to cause a short circuit. Therefore, it is required to uniformly pressurize each in-plane location of the cell 10 with an appropriate load.

Further, in the cell using the solid electrolyte, it is important to densify the solid electrolyte and increase adhesion between the electrodes and the solid electrolyte in order to smooth movement of ions between the electrodes. Therefore, it is required to uniformly pressurize each in-plane location of the cell 10 with an appropriate load.

The cushioning member 11 is a pouch in which a fluid such as a gas or a liquid is sealed in a bag-shaped insulating packaging material. Based on isotropy of a fluid pressure inside the cushioning member 11, a load acting on each in-plane location of the cell 10 sandwiched between two adjacent cushioning members 11 is equalized. The cushioning member 11 is not limited to the above-described pouch as long as the cushioning member 11 has cushioning properties and pressure equalization properties.

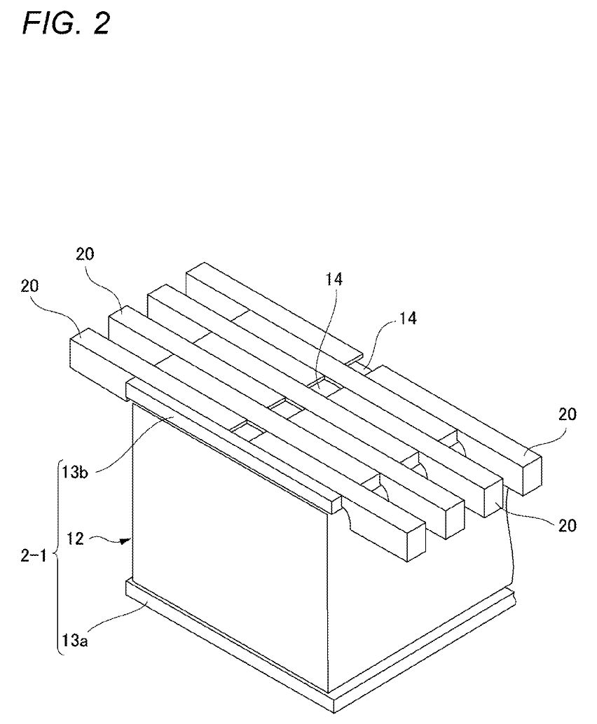

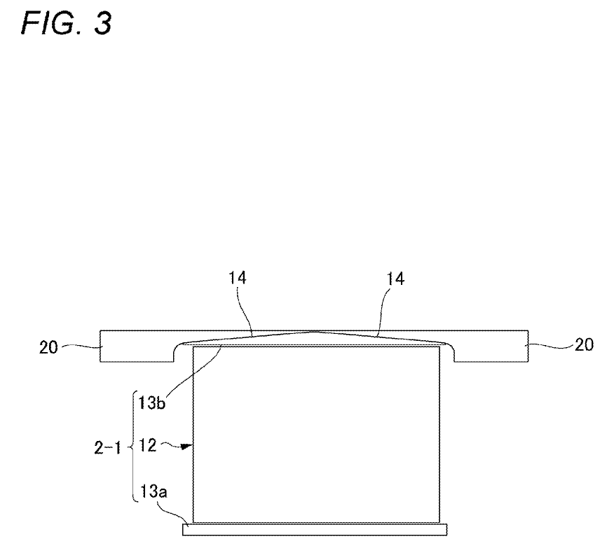

An example of a method for manufacturing the battery 1 will be described with reference to FIGS. 2-7. Hereinafter, the laminating direction of the cells 10 and the cushioning members 11 in the laminate 12 of each assembly and the stacking direction of the first assembly and the second assembly will be described as an upper-lower direction for convenience.

FIGS. 2-4 show an example of pressing members used for manufacturing the battery 1. First pressing members 20 press an upper plate 13b of the first assembly 2-1. An upper surface of the upper plate 13b facing outward in the laminating direction of the cells 10 and the cushioning members 11 is provided with accommodating recesses 14. Each of the accommodating recesses 14 extends from a side surface of the upper plate 13b along a first direction (X direction) within the upper surface of the upper plate 13b.

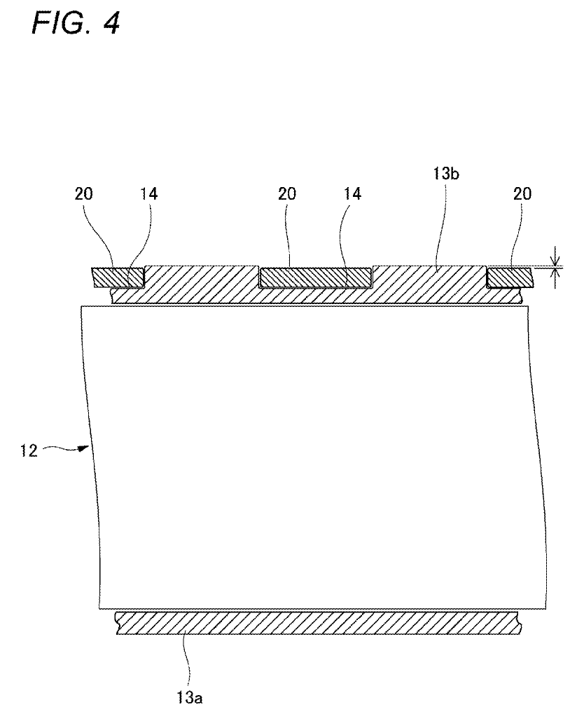

The first pressing members 20 are respectively accommodated in the accommodating recesses 14. One end portion of the first pressing member 20 in the first direction (X direction) extends from the accommodating recess 14. As shown in FIG. 4, in a state where each of the first pressing members 20 is accommodated in a corresponding one of the accommodating recesses 14, the upper surface of the upper plate 13b protrudes further upward than the first pressing member 20.

A bottom surface of the accommodating recess 14 is inclined away from the upper surface of the upper plate 13b toward an opening in the side surface of the upper plate 13b. The first pressing member 20 is formed in a tapered shape to match the bottom surface of the accommodating recess 14.

Each of the first pressing member 20 and the accommodating recess 14 is provided on both sides in the first direction (X direction) in the upper plate 13b. On each of one side and the other side in the first direction, a plurality of first pressing members 20 and a plurality of accommodating recesses 14 are provided at intervals in a second direction (Y direction) intersecting the first direction in the upper surface of the upper plate 13b.

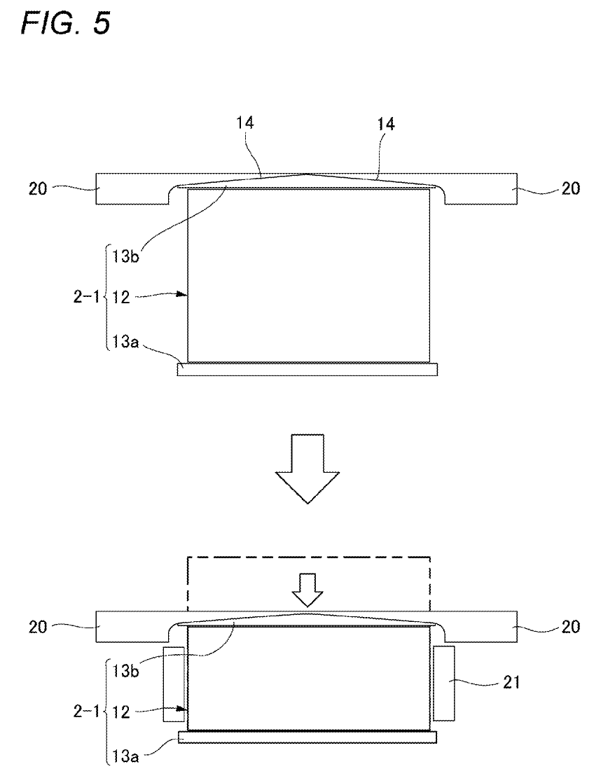

As shown in FIG. 5, the first assembly 2-1 is installed in a pressurizing device. A lower plate 13a of the first assembly 2-1 is supported by the pressurizing device. The first pressing members 20 are accommodated in the respective accommodating recesses 14 in the upper plate 13b of the first assembly 2-1.

Then, a load in the upper-lower direction is applied to the upper plate 13b of the first assembly 2-1, and the laminate 12 of the first assembly 2-1 is compressed in the laminating direction. In a state where the laminate 12 is compressed, the first pressing members 20 are appropriately fixed, and the upper plate 13b is pressed by the first pressing members 20. Accordingly, the laminate 12 is maintained in a compressed state. While the laminate 12 of the first assembly 2-1 is being compressed and the upper plate 13b is being pressed by the first pressing members 20 to maintain the state where the laminate 12 is compressed, both side surfaces of the laminate 12 in the first direction (X direction) are supported by side surface support members 21.

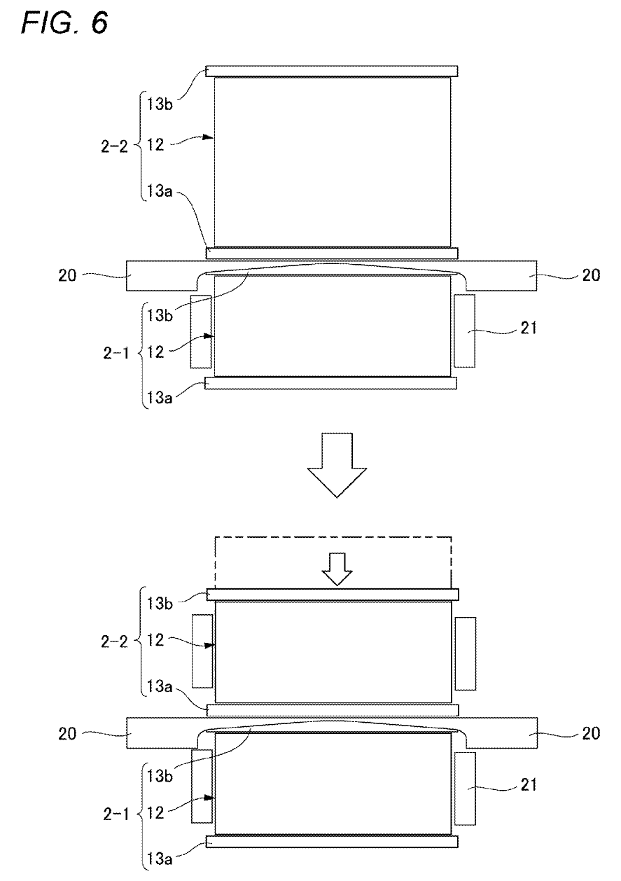

Next, as shown in FIG. 6, the second assembly 2-2 is stacked on the first assembly 2-1. The lower plate 13a of the second assembly 2-2 is overlapped with the upper plate 13b of the first assembly 2-1. Then, a load in the upper-lower direction is applied to the upper plate 13b of the second assembly 2-2, and the laminate 12 of the second assembly 2-2 is compressed in the laminating direction. While the laminate 12 of the second assembly 2-2 is being compressed, both side surfaces of the laminate 12 in the first direction (X direction) are supported by side surface support members 22.

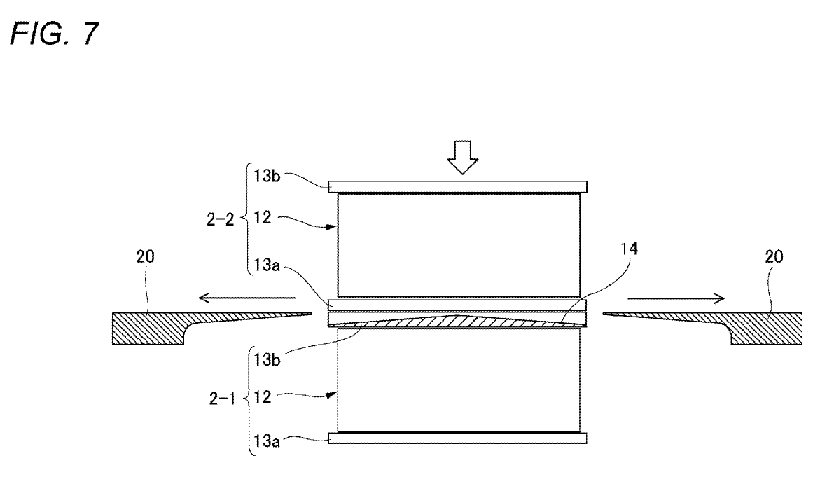

Then, as shown in FIG. 7, the first pressing members 20 are removed along the first direction (X direction) in a state where the load is applied to the upper plate 13b of the second assembly 2-2. As shown in FIG. 4, in the state where each of the first pressing members 20 is accommodated in the corresponding one of the accommodating recesses 14, the upper surface of the upper plate 13b of the first assembly 2-1 protrudes further upward than the first pressing member 20. When the load is applied to the upper plate 13b of the first assembly 2-1 via the second assembly 2-2, the upper plate 13b sinks with respect to the first pressing member 20, and a gap is generated between the first pressing member 20 and the bottom surface of the accommodating recess 14. Therefore, friction between the first pressing member 20 and the upper plate 13b is reduced, and the first pressing member 20 is easily removed in the first direction.

Thereafter, the frames 4 are assembled to the lower plate 13a of the first assembly 2-1 and the upper plate 13b of the second assembly 2-2, and the load applied to the upper plate 13b of the second assembly 2-2 is removed.

In the method for manufacturing the battery 1 shown in FIGS. 5-7, the first assembly 2-1 and the second assembly 2-2 are sequentially stacked, and each time one assembly is stacked, the laminate 12 of the assembly is compressed. The number of cells 10 and the number of cushioning members 11 provided in the laminate 12 of each assembly are smaller than those of all the cells 10 and the cushioning members 11 constituting the battery 1, and the uncompressed height of the laminate 12 is smaller. Accordingly, the pressurizing device can be downsized.

Further, since the number of cells 10 and the number of cushioning members 11 provided in the laminate 12 of each assembly are small, a positional displacement of the cells 10 and the cushioning members 11 during compression is suppressed. Accordingly, the cells 10 and the cushioning member 11 can be compressed while maintaining a state in which the cells 10 and the cushioning member 11 are aligned in the laminating direction. Further, by maintaining the state in which the cells 10 and the cushioning members 11 are aligned in the laminating direction, the frames 4 can be easily assembled. Further, each in-plane location intersecting the thickness direction of the cell 10 can be uniformly pressed. This is useful when the cell 10 is a cell using the solid electrolyte, and is useful when the cell 10 includes a negative electrode made of the metallic lithium or the like.

The first pressing members 20 that press the upper plate 13b of the first assembly 2-1 are sandwiched between the first assembly 2-1 and the second assembly 2-2, but by applying a load to the first assembly 2-1 and the second assembly 2-2, the friction between the first pressing members 20 and the upper plate 13b is reduced, and the first pressing members 20 are easily removed in the first direction.

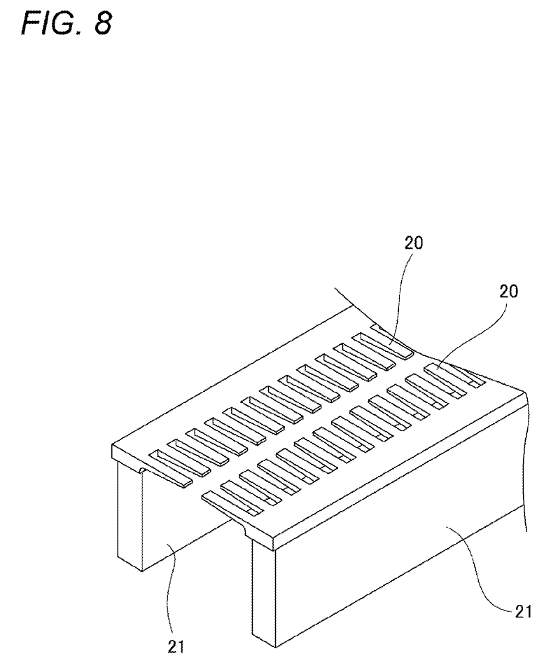

Preferably, as shown in FIG. 5, while the upper plate 13b of the first assembly 2-1 is being pressed by the first pressing members 20, both side surfaces of the laminate 12 in the first direction (X direction) are supported by the side surface support members 21. Accordingly, the positional displacement of the cells 10 and the cushioning members 11 can be further suppressed. As shown in FIG. 8, the first pressing members 20 and the side surface support members 21 may be integrally formed.

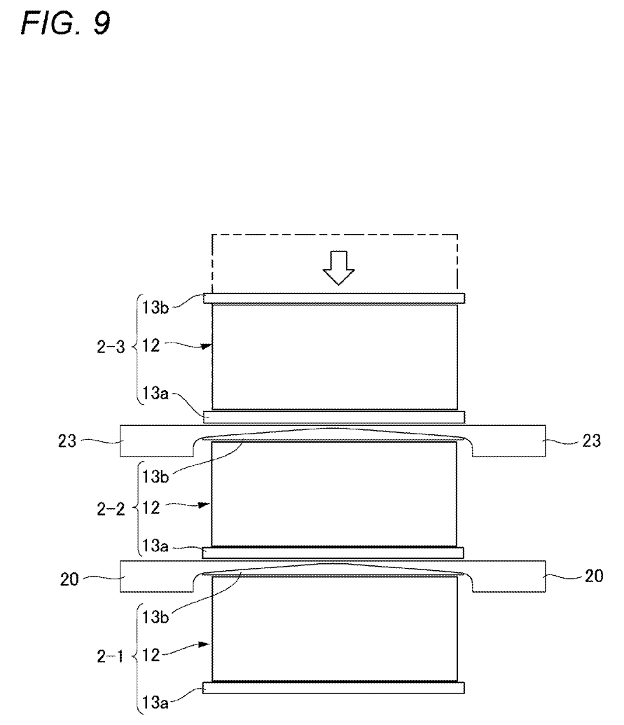

As shown in FIG. 9, a third assembly 2-3 may be further stacked, and in this case, the upper plate 13b of the second assembly 2-2 is pressed by second pressing members 23 in a state where the laminate 12 of the second assembly 2-2 is compressed. The upper plate 13b of the second assembly 2-2 is configured similarly to the upper plate 13b of the first assembly 2-1, and each of the second pressing members 23 is configured similarly to the first pressing member 20. In a state where the third assembly 2-3 is stacked, the laminate 12 of the third assembly 2-3 is compressed, and a load is applied to the upper plate 13b of the third assembly 2-3, the first pressing members 20 and the second pressing members 23 are removed along the first direction (X direction).

A process of stacking the third assembly 2-3 on the first assembly 2-1 and the second assembly 2-2 is basically the same as a process of stacking the second assembly 2-2 shown in FIG. 6 on the first assembly 2-1 when the first assembly 2-1 and the second assembly 2-2 are regarded as one assembly.

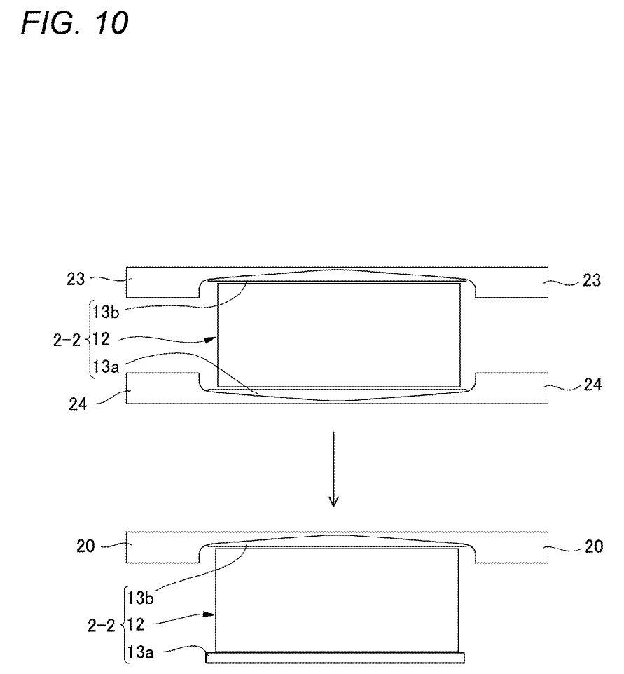

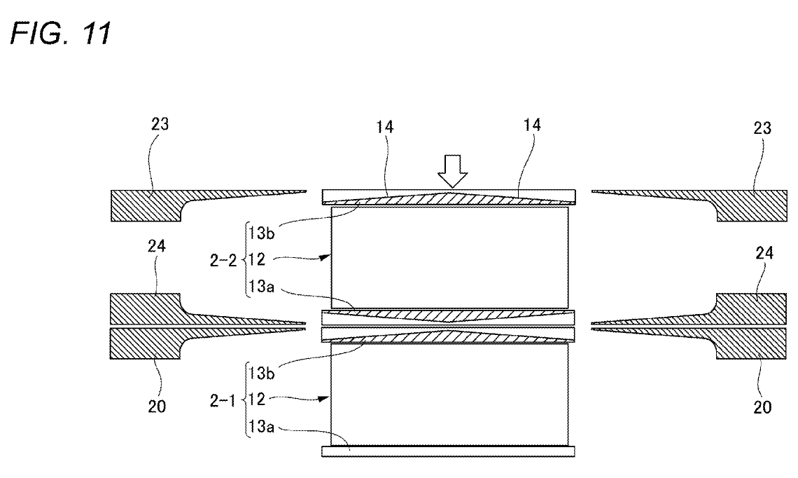

A method for manufacturing a modification of the battery 1 will be described with reference to FIGS. 10 and 11. In the method for manufacturing the battery 1 shown in FIGS. 5-7, the first assembly 2-1 and the second assembly 2-2 are sequentially stacked, and each time one assembly is stacked, the laminate 12 of the assembly is compressed. Meanwhile, in the manufacturing method to be described below, the laminates 12 of the first assembly 2-1 and the second assembly 2-2 are individually compressed in advance.

The lower plate 13a of the first assembly 2-1 is supported by the pressurizing device, and the upper plate 13b is pressed by the first pressing members 20 to maintain a state where the laminate 12 of the first assembly 2-1 is compressed. The lower plate 13a of the second assembly 2-2 is supported by plate support members 24, and the upper plate 13b of the second assembly 2-2 is pressed by the second pressing members 23 to maintain a state where the laminate 12 of the second assembly 2-2 is compressed.

A lower surface of the lower plate 13a of the second assembly 2-2 is provided with accommodating recesses 15, and the plate support members 24 are respectively accommodated in the accommodating recesses 15. In a state where each of the plate support members 24 is accommodated in a corresponding one of the accommodating recesses 15, the lower surface of the lower plate 13a protrudes further downward than the plate support member 24. A bottom surface of the accommodating recess 15 is inclined away from the lower surface of the lower plate 13a toward an opening in the side surface of the lower plate 13a. The plate support member 24 is formed in a tapered shape to match the bottom surface of the accommodating recess 15.

As shown in FIG. 11, the second assembly 2-2 is stacked on the first assembly 2-1, and a load is applied to the upper plate 13b of the second assembly 2-2. In the state where the load is applied to the upper plate 13b, the first pressing members 20, the second pressing members 23, and the plate support members 24 are removed along the first direction (X direction).

Since the laminates 12 of the first assembly 2-1 and the second assembly 2-2 are individually compressed in advance, the first assembly 2-1 and the second assembly 2-2 may just be stacked, and assemblability is excellent.

The embodiment of the present invention has been described above, but the present invention is not limited to the embodiment described above, and modifications, improvements, and the like can be made as appropriate. In the present description, at least the following matters are described. Although corresponding constituent elements or the like in the embodiment described above are shown in parentheses, the present invention is not limited thereto.

(1) A method for manufacturing a battery (battery 1) in which a plurality of cushioning members (cushioning members 11) and a plurality of cells (cells 10) each disposed between adjacent two of the cushioning members are laminated, the battery including:
a first assembly (first assembly 2-1) that includes
a first laminate (laminate 12) including one or more of the cells and two or more of the cushioning members, and
a pair of first plates (first plates 13) configured to compressively sandwich the first laminate in a laminating direction, and
a second assembly (second assembly 2-2) that includes
a second laminate (laminate 12) including one or more of the cells and two or more of the cushioning members, and
a pair of second plates (plates 13) configured to compressively sandwich the second laminate in a laminating direction, the method comprising:
compressing the first laminate of the first assembly, supporting one of the first plates, and pressing the other of the first plates by a first pressing member (first pressing member 20); and
overlapping one of the second plates with the other of the first plates to stack the second assembly on the first assembly, wherein
the first pressing member is accommodated in an accommodating recess (accommodating recess 14) provided in a surface of the other of the first plates facing outward in the laminating direction, and the surface of the other of the first plates protrudes further outward in the laminating direction than the first pressing member, and
the first assembly and the second assembly are pressurized in the laminating direction, and in the pressurized state, the first pressing member is removed in a first direction intersecting the laminating direction.

According to the method for manufacturing the battery in the above (1), since the number of cells and the number of cushioning members provided in the laminate of each assembly are smaller than those of all the cells and the cushioning members constituting the battery, and the laminate before the compression is reduced in height, a pressurizing device can be downsized. Further, since the number of cells and the number of cushioning members provided in the laminate of each assembly are small, a positional displacement of the cells and the cushioning members during the compression is suppressed. The first pressing member is sandwiched between the first assembly and the second assembly, but by applying a load to the first assembly and the second assembly, friction between the first pressing member and the accommodating recess is reduced, and the first pressing member can be easily removed in the first direction.

(2) The method for manufacturing the battery according to the above (1), in which
each of the first pressing member and the accommodating recess is provided on both sides in the first direction in the surface of the other of the first plates.

According to the method for manufacturing the battery in the above (2), a length of the first pressing member in the first direction can be shortened, and the first pressing member is more easily removed in the first direction.

(3) The method for manufacturing the battery according to the above (2), in which
a plurality of the first pressing members and a plurality of the accommodating recesses are each provided at intervals in a second direction intersecting the first direction in the surface of the other of the first plates.

According to the method for manufacturing the battery in the above (3), the first plate of the first assembly can be stably pressed by the first pressing members.

(4) The method for manufacturing the battery according to the above (1), in which
while the other of the first plates is being pressed by the first pressing member, both side surfaces of the first laminate in the first direction are supported by side surface support members (side surface support members 21).

According to the method for manufacturing the battery in the above (4), the positional displacement of the cells and the cushioning members can be further suppressed.

(5) The method for manufacturing the battery according to the above (4), in which
the first pressing member and the side surface support members are integrally formed.

According to the method for manufacturing the battery in the above (5), a manufacturing process of the battery can be simplified.

(6) The method for manufacturing the battery according to the above (1), in which
a bottom surface of the accommodating recess is inclined away from the surface of the first plate toward a removal opening from which the first pressing member is removed, and
the first pressing member is formed in a tapered shape to match the bottom surface of the accommodating recess.

According to the method for manufacturing the battery in the above (6), the first pressing member is more easily removed in the first direction.

(7) The method for manufacturing the battery according to the above (1), in which
the second laminate of the second assembly stacked on the first assembly is not compressed, and
the second laminate is compressed when the first assembly and the second assembly are pressurized.

According to the method for manufacturing the battery in the above (7), since the compression of the second laminate and the removal of the first pressing member can be performed by a series of pressurization on the first assembly and the second assembly, assemblability is excellent.

(8) The method for manufacturing the battery according to the above (1), in which
the second laminate of the second assembly stacked on the first assembly is compressed, and to maintain a state where the second laminate is compressed, the one of the second plates is supported by a plate support member (plate support member 24) and the other of the second plates is pressed by a second pressing member (second pressing member 23), and
the plate support member is accommodated in an accommodating recess (accommodating recess 15) provided in a surface of the one of the second plates facing outward in the laminating direction, and the surface of the one of the second plates protrudes further outward in the laminating direction than the plate support member, and
the second pressing member is accommodated in an accommodating recess (accommodating recess 14) provided in a surface of the other of the second plates facing outward in the laminating direction, and the surface of the other of the second plates protrudes further outward in the laminating direction than the second pressing member, and
the other of the second plates of the second assembly stacked on the first assembly is pressurized toward the first assembly, and in the pressurized state, the first pressing member is removed along the first direction intersecting a stacking direction of the first assembly and the second assembly, and
the first assembly and the second assembly are pressurized in the laminating direction, and in the pressurized state, the plate support member and the second pressing member are removed along the first direction intersecting the laminating direction.

According to the method for manufacturing the battery in the above (8), since the laminates of the first assembly and the second assembly are individually compressed in advance, the assemblability is excellent.

(9) The method for manufacturing the battery according to any one of the above (1) to (8), in which
each of the cells includes a solid electrolyte.

(10) The method for manufacturing the battery according to any one of the above (1) to (8), in which
a negative electrode of each of the cells contains metallic lithium or an alloy containing metallic lithium.

(11) The method for manufacturing the battery according to any one of the above (1) to (8), in which
a negative electrode of each of the cells contains silicon.

(12) The method for manufacturing the battery according to any one of the above (1) to (8), in which
each of the cushioning members includes a fluid sealed in a packaging material.

### REFERENCE SIGNS LIST

1 battery
2-1 first assembly
2-2 second assembly
2-3 third assembly
4 frame
10 cell
11 cushioning member
12 laminate
13a lower plate
13b upper plate
14 accommodating recess
15 accommodating recess
20 first pressing member
21 side surface support member
22 side surface support member
23 second pressing member
24 plate support member

What is claimed is:

1. A method for manufacturing a battery in which a plurality of cushioning members and a plurality of cells each disposed between adjacent two of the cushioning members are laminated, the battery including:
a first assembly that includes
a first laminate including one or more of the cells and two or more of the cushioning members, and
a pair of first plates configured to compressively sandwich the first laminate in a laminating direction, and
a second assembly that includes
a second laminate including one or more of the cells and two or more of the cushioning members, and
a pair of second plates configured to compressively sandwich the second laminate in the laminating direction, the method comprising:
compressing the first laminate of the first assembly, supporting one of the first plates, and pressing other of the first plates by a first pressing member; and
overlapping one of the second plates with the other of the first plates to stack the second assembly on the first assembly, wherein
the first pressing member is accommodated in an accommodating recess provided in a surface of the other of the first plates facing outward in the laminating direction, and the surface of the other of the first plates protrudes further outward in the laminating direction than the first pressing member, and
the first assembly and the second assembly are pressurized in the laminating direction, and in the pressurized state, the first pressing member is removed in a first direction intersecting the laminating direction.

2. The method for manufacturing the battery according to claim 1, wherein
each of the first pressing member and the accommodating recess is provided on both sides in the first direction in the surface of the other of the first plates.

3. The method for manufacturing the battery according to claim 2, wherein
a plurality of the first pressing members and a plurality of the accommodating recesses are each provided at intervals in a second direction intersecting the first direction in the surface of the other of the first plates.

4. The method for manufacturing the battery according to claim 1, wherein
while the other of the first plates is being pressed by the first pressing member, both side surfaces of the first laminate in the first direction are supported by side surface support members.

5. The method for manufacturing the battery according to claim 4, wherein
the first pressing member and the side surface support members are integrally formed.

6. The method for manufacturing the battery according to claim 1, wherein
a bottom surface of the accommodating recess is inclined away from the surface of the first plate toward a removal opening from which the first pressing member is removed, and
the first pressing member is formed in a tapered shape to match the bottom surface of the accommodating recess.

7. The method for manufacturing the battery according to claim 1, wherein
the second laminate of the second assembly stacked on the first assembly is not compressed, and
the second laminate is compressed when the first assembly and the second assembly are pressurized.

8. The method for manufacturing the battery according to claim 1, wherein
the second laminate of the second assembly stacked on the first assembly is compressed, and to maintain a state where the second laminate is compressed, the one of the second plates is supported by a plate support member and the other of the second plates is pressed by a second pressing member, and
the plate support member is accommodated in an accommodating recess provided in a surface of the one of the second plates facing outward in the laminating direction, and the surface of the one of the second plates protrudes further outward in the laminating direction than the plate support member, and
the second pressing member is accommodated in an accommodating recess provided in a surface of other of the second plates facing outward in the laminating direction, and the surface of the other of the second plates protrudes further outward in the laminating direction than the second pressing member, and
the other of the second plates of the second assembly stacked on the first assembly is pressurized toward the first assembly, and in the pressurized state, the first pressing member is removed along the first direction intersecting a stacking direction of the first assembly and the second assembly, and
the first assembly and the second assembly are pressurized in the laminating direction, and in the pressurized state, the plate support member and the second pressing member are removed along the first direction intersecting the laminating direction.

9. The method for manufacturing the battery according to claim 1, wherein
each of the cells includes a solid electrolyte.

10. The method for manufacturing the battery according to claim 2, wherein
each of the cells includes a solid electrolyte.

11. The method for manufacturing the battery according to claim 3, wherein
each of the cells includes a solid electrolyte.

12. The method for manufacturing the battery according to claim 1, wherein
a negative electrode of each of the cells contains metallic lithium or an alloy containing metallic lithium.

13. The method for manufacturing the battery according to claim 2, wherein
a negative electrode of each of the cells contains metallic lithium or an alloy containing metallic lithium.

14. The method for manufacturing the battery according to claim 3, wherein
a negative electrode of each of the cells contains metallic lithium or an alloy containing metallic lithium.

15. The method for manufacturing the battery according to claim 1, wherein
a negative electrode of each of the cells includes silicon.

16. The method for manufacturing the battery according to claim 2, wherein
a negative electrode of each of the cells includes silicon.

17. The method for manufacturing the battery according to claim 3, wherein
a negative electrode of each of the cells includes silicon.

18. The method for manufacturing the battery according to claim 1, wherein
each of the cushioning members includes a fluid sealed in a packaging material.

19. The method for manufacturing the battery according to claim 2, wherein
each of the cushioning members includes a fluid sealed in a packaging material.

20. The method for manufacturing the battery according to claim 3, wherein
each of the cushioning members includes a fluid sealed in a packaging material.
